(19) United States
(12) Patent Application Publication
(10) Pub. No.: US 2018/0186022 A1
(43) Pub. Date: Jul. 5, 2018

(54) FOOD PRODUCT SLICING APPARATUS INCLUDING A PIVOTAL GATE ASSOCIATED WITH A FOOD PRODUCT TRAY

(71) Applicant: Provisur Technologies, Inc., Chicago, IL (US)

(72) Inventors: Gage A. Fox, Manhattan, IL (US); Glen F. Pryor, Manhattan, IL (US); Ryan M. Torrenga, Bourbonnais, IL (US); Ryan J. O'Connor, Bolingbrook, IL (US)

(21) Appl. No.: 15/836,273

(22) Filed: Dec. 8, 2017

Related U.S. Application Data
(60) Provisional application No. 62/441,646, filed on Jan. 3, 2017.

(51) Int. Cl. B26D 5/20; B26D 3/28; A22C 17/00; B26D 7/06; B26D 5/00

(52) U.S. Cl. CPC B26D 5/20; B26D 3/28; B26D 2210/04; B26D 7/0625; B26D 5/005; A22C 17/002

(57) ABSTRACT

In one aspect, a food product tray includes a pan including a top surface, a front end and a rear end, at least one side member extending upward from the pan, and a gate positioned near the front end of the pan. The gate is moveable between a blocking position, in which a top edge of the gate is positioned above the top surface of the pan, and a non-blocking position, in which the top edge is either at or below the top surface of the pan. During movement of the gate, the gate rotates relative to the front end of the pan about an axis displaced from the gate. In one aspect, a slicing apparatus includes a food product tray including a gate movable along an arcuate path defined by an axis displaced from the gate and a radius between the arcuate path and the axis.

### RELATED APPLICATIONS

The present application claims the priority benefit of co-pending U.S. Provisional Patent Application No. 62/441,646, filed Jan. 3, 2017, which is incorporated by reference herein.

### FIELD OF THE INVENTION

The present disclosure generally relates to food product slicing apparatuses and, more particularly, to a food product tray of a food product slicing apparatus.

### BACKGROUND

Several types of food products are sliced for presentation in retail environments and for consumption. Exemplary food products include cheese, meat, among others. Such food products may be sliced in a wide variety of manners. For example, a food product slicing apparatus or machine may receive one or more food product loaves or logs, which are elongated logs of the food product, onto a food product tray. A gate is located at a front end of the product tray and acts as a limit or stop to advancement of the food product logs into the slicing apparatus. Food product logs have a relatively considerable weight and can be loaded, inserted or forced into the machine under relatively great force, thereby resulting in the log applying a great force to the gate at the front of the food product tray.

After loading of the food product logs into the slicing apparatus, the gate is moved out of the way of the log prior to further advancement of the food product log toward a slicing blade where the food product log is eventually sliced. The gate is typically oriented in a plane perpendicular to the direction of travel of the food product log into the machine. The gate is also retracted or moved out of the path of the food product log in the same plane that is perpendicular to the direction of travel. With the immense pressure or force applied to the gate by the food product log(s), the gate may not be able to retract. This results in an operational failure requiring maintenance or attention by an operator to correct the failure. Furthermore, this failure increases downtime of the slicing apparatus which results in lower yield.

Still further, retracting the gate in a plane perpendicular to the direction of travel of the food product log can shear a leading edge of the food product log, thereby damaging or otherwise negatively affecting the leading edge of the food product log.

### SUMMARY

In one aspect, a slicing apparatus is provided and includes a pivotal gate.

In one aspect, a slicing apparatus is provided and includes a food product tray including a pivotal gate.

In one aspect, a slicing apparatus is provided and includes a food product tray including a pivotal gate that pivots away and downward relative to a front end of the tray.

In one aspect, a food product tray for a slicing apparatus is provided. The food product tray includes a pan including a top surface oriented in a plane, the pan including a front end and a rear end. The food product tray also includes at least one side member and a gate positioned near the front end of the pan. The gate is moveable between a blocking position, in which a top edge of the gate is positioned above the top surface of the pan, and a non-blocking position, in which the top edge of the gate is either at or below the top surface of the pan. During movement of the gate from the blocking position to the non-blocking position, the gate rotates away from the front end of the pan.

In one aspect, the gate may rotate away and downward from the front end of the pan when the gate moves from the blocking position to the non-blocking position.

In one aspect, a food product tray for a slicing apparatus is provided and includes a pan including a top surface, a front end and a rear end, at least one side member extending upward from the pan, and a gate positioned near the front end of the pan. The gate is moveable between a blocking position, in which a top edge of the gate is positioned above the top surface of the pan, and a non-blocking position, in which the top edge of the gate is either at or below the top surface of the pan. During movement of the gate from the blocking position to the non-blocking position, the gate rotates relative to the front end of the pan about an axis displaced from the gate.

In one aspect, the gate may rotate away and downward from the front end of the pan when the gate moves from the blocking position to the non-blocking position.

In one aspect, the entire gate may rotate away and downward from the front end of the pan.

In one aspect, with the gate in the blocking position, the gate may be spaced-apart from the front end of the pan.

In one aspect, the axis may be positioned between the front end and the rear end of the pan.

In one aspect, the gate may be positioned on a first side of the front end of the pan and the axis may be positioned on a second side of the front end of the pan opposite the first side.

In one aspect, with the gate in the non-blocking position, the top edge of the gate may be below the top surface of the pan.

In one aspect, with the gate in the non-blocking position, food product configured to be supported on the pan and advanced off of a front end of the pan may not engage the gate.

In one aspect, the food product tray may further include a frame member coupled to the gate. The frame member may be rotatable about the axis, and rotation of the frame member about the axis may move the gate between the blocking position and the non-blocking position.

In one aspect, the food product tray may further include a second frame member. The first frame member and the second frame member may interact to define the blocking position and the non-blocking position.

In one aspect, the first frame member may define a first slot therein and the second frame member may define a second slot therein. The first slot and the second slot may be transversely oriented relative to each other.

In one aspect, the food product tray may further include a first guide member at least partially positioned in the first slot and a second guide member at least partially positioned in the second slot. The first guide member may move within the first slot and the second guide member may move within the second slot as the gate moves between the blocking position and the non-blocking position.

In one aspect, at least one of the first guide member and the second guide member may engage an end of a respective one of the first slot and the second slot to define one of the blocking position and the non-blocking position.

In one aspect, a slicing apparatus is provided and includes a housing, a slicing blade supported by the housing and configured to move in order to slice food product and a food product tray supported by and movable relative to the housing between a loading position, in which the food product tray is configured to receive at least one food product thereon, and an operating position, in which the food product is raised relative to the loading position. The food product tray includes a pan including a top surface, a front end and a rear end, at least one side member extending upward from the pan, and a gate positioned near the front end of the pan. The gate is moveable between a blocking position, in which a top edge of the gate is positioned above the top surface of the pan and is configured to inhibit the at least one food product from advancing past the gate, and a non-blocking position, in which the top edge of the gate is moved to a position lower than in the blocking position to allow the at least one food product to advance past the gate. The gate moves along an arcuate path during movement of the gate from the blocking position to the non-blocking position, and the arcuate path is defined by an axis displaced from the gate and a radius between the arcuate path and the axis. The slicing apparatus also includes an infeed member configured to engage the at least one food product supported on the food product tray. The infeed member is configured to advance the at least one food product past the gate and toward the slicing blade with the gate in the non-blocking position.

In one aspect, the gate may rotate away from the front end of the pan and downward when the gate moves from the blocking position to the non-blocking position.

In one aspect, with the gate in the blocking position, the gate may be spaced-apart from the front end of the pan.

In one aspect, the axis may be positioned between the front end and the rear end of the pan.

In one aspect, the gate may be positioned on a first side of the front end of the pan and the axis may be positioned on a second side of the front end of the pan opposite the first side.

In one aspect, with the gate in the non-blocking position, the top edge of the gate may be at or below the top surface of the pan.

In one aspect, with the gate in the non-blocking position, the at least one food product may not engage the gate as the infeed member advances the at least one food product past the gate.

In one aspect, the food product tray may further include a frame member coupled to the gate. The frame member may be rotatable about the axis, and rotation of the frame member about the axis may move the gate between the blocking position and the non-blocking position.

In one aspect, the food product tray may further include a second frame member. The first frame member and the second frame member may interact to define the blocking position and the non-blocking position.

In one aspect, the first frame member may define a first slot therein and the second frame member may define a second slot therein. The first slot and the second slot may be transversely oriented relative to each other.

In one aspect, the food product tray may further include a first guide member at least partially positioned in the first slot and a second guide member at least partially positioned in the second slot. The first guide member may move within the first slot and the second guide member may move within the second slot as the gate moves between the blocking position and the non-blocking position.

In one aspect, at least one of the first guide member and the second guide member may engage an end of a respective one of the first slot and the second slot to define one of the blocking position and the non-blocking position.

### BRIEF DESCRIPTION OF THE DRAWINGS

The disclosure can be better understood with reference to the following drawings and description. The components in the figures are not necessarily to scale, emphasis instead being placed upon illustrating principles of the disclosure.

FIG. 1 is a top, front perspective view of one example of a food product slicing apparatus or machine, according to one aspect of the present disclosure.

FIG. 2 is a top, rear perspective view of the slicing apparatus shown in FIG. 1, according to one aspect of the present disclosure.

FIG. 3 is a side elevational view of the slicing apparatus shown in FIG. 1, according to one aspect of the present disclosure.

FIG. 4 is a rear elevational view of the slicing apparatus shown in FIG. 1, according to one aspect of the present disclosure.

FIG. 5 is a top, rear perspective view of a portion of the slicing apparatus shown in FIG. 1 including one example of a food product tray and one example of a gate with the gate shown in an upward or blocking position, according to one aspect of the present disclosure.

FIG. 6 is a bottom, rear perspective view of the portion of the slicing apparatus, tray and gate shown in FIG. 5, according to one aspect of the present disclosure.

FIG. 7 is a side elevational view of the portion of the slicing apparatus, tray and gate shown in FIG. 5 with the gate in the upward or blocking position, according to one aspect of the present disclosure.

FIG. 8 is a side elevational view similar to FIG. 7 with the gate shown in a lowered or non-blocking position shown in solid lines and one example of an intermediate position shown in phantom dashed lines, according to one aspect of the present disclosure.

FIG. 9 is an exploded view of a portion of the slicing apparatus and the tray, according to one aspect of the present disclosure.

FIG. 10 is another exploded view of a portion of the slicing apparatus and the tray, according to one aspect of the present disclosure.

FIG. 11 is a side elevational view of another example of a portion of the slicing apparatus and the tray with the gate shown in another example of an upward or blocking position, according to one aspect of the present disclosure.

FIG. 12 is a top, rear perspective view of another example of a portion of the slicing apparatus and tray including one example of a transport mechanism associated with the tray to transport or convey one or more food product logs onto the tray, according to one aspect of the present disclosure.

### DETAILED DESCRIPTION

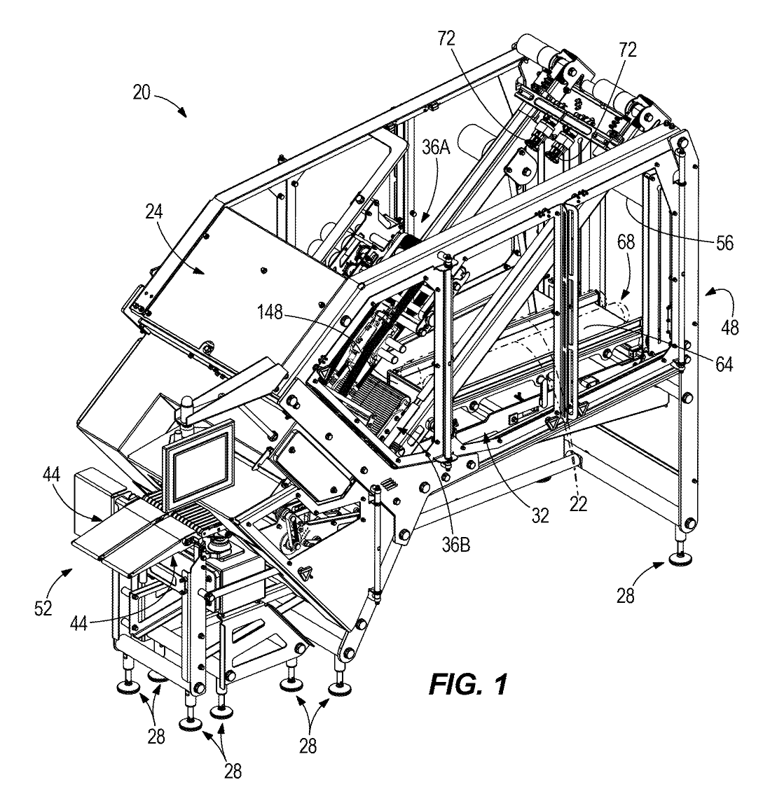

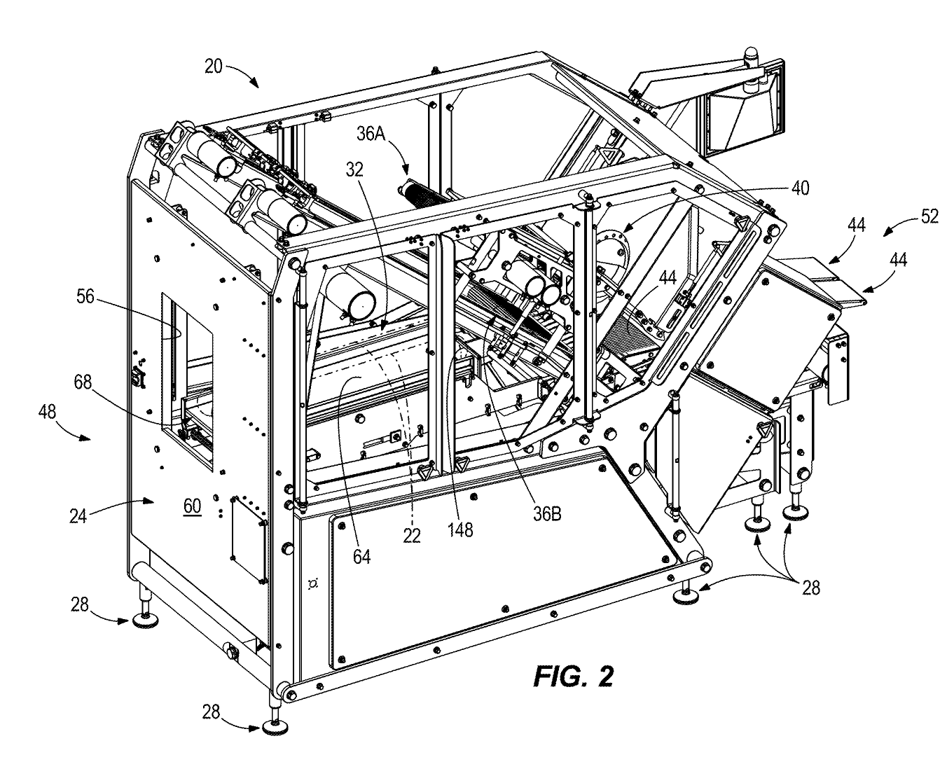

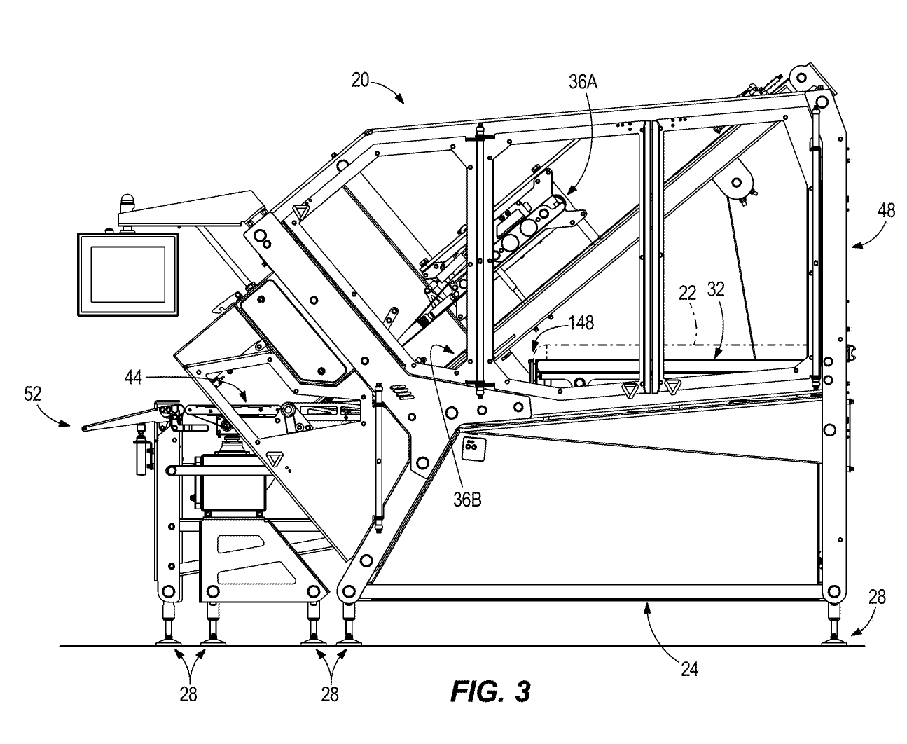

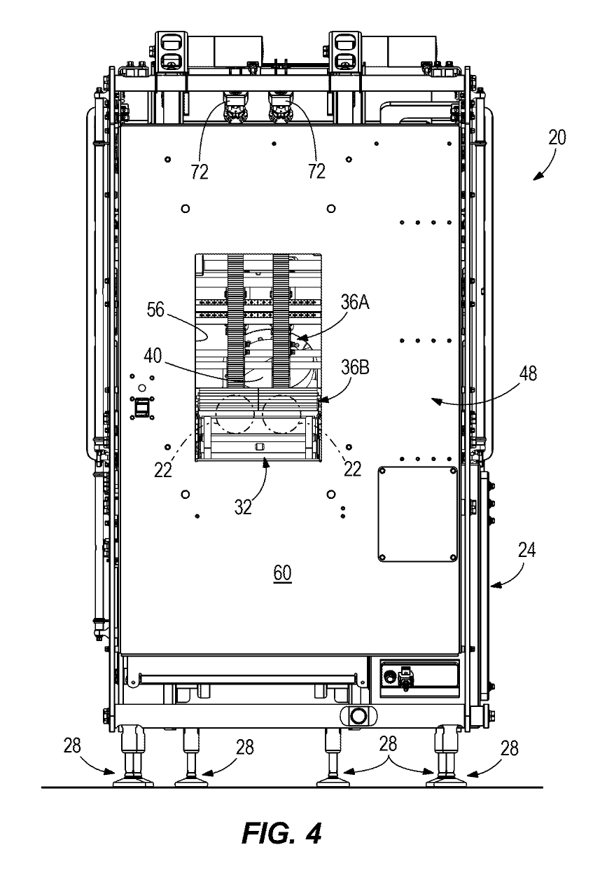

Referring to FIGS. 1-4, one example of a food product slicing apparatus or machine 20 is illustrated and is configured to slice a wide variety of food products including, but not limited to, cheese, meat, among others. The food products may have a wide variety of shapes and sizes. In one example, the slicing apparatus 20 is configured to slice food products 22 have an elongated shape sometimes referred to as a log or loaf 22. The illustrated example of the slicing apparatus 20 is configured to slice varying quantities of food product logs 22 including, but not limited to, one, two or more than two logs.

With continued reference to FIGS. 1-4, the illustrated example of the slicing apparatus 20 includes a housing or frame 24, a plurality of legs or supports 28 for supporting the slicing apparatus 20 on a floor or ground, a food product tray 32, infeed members 36, a slicing blade 40, output members 44, and a control system 48 configured to perform the necessary operations and commands to operate the slicing apparatus 20 in a desired manner. The slicing apparatus 20 has a rear or loading end 48 and a front or output end 52. One or more food product logs 22 are input or loaded into the slicing apparatus 20 through an opening 56 defined in a rear surface 60 of the housing 24. The opening 56 is aligned with the tray 32 such that introduction of the one or more logs 22 through the opening 56 results in the logs 22 sliding onto a top surface 64 of a pan 68 of the tray 32. The tray 32 is pivotal upward to orient the one or more food logs 22 at an angle between horizontal and vertical. The one or more logs 22 may be gripped by one or more grippers 72 at a rear end of the logs 22 in preparation of feeding the logs 22 toward the slicing blade 40. Additionally, in one example, the infeed members 36 include at least one upper infeed member 36A configured to engage a top or upper surface of the one or more logs 22 and at least one lower infeed member 36B configured to engage a bottom or lower surface of the one or more logs 22. The upper and lower infeed members 36A, 36B assist with feeding or advancing the one or more food logs 22 toward the slicing blade 40. In the illustrated example, the upper and lower infeed members 36A, 36B are conveyors driven by one or more motors. The infeed members 36 along with the grippers 72 advance the one or more food logs 22 toward the slicing blade 40 where the one or more food logs 22 are sliced into slices. The slices of food product fall onto the one or more output members 44, which advance or move the slices downstream for further processing. In the illustrated example, the one or more output members 44 are one or more conveyors driven by one or more motors.

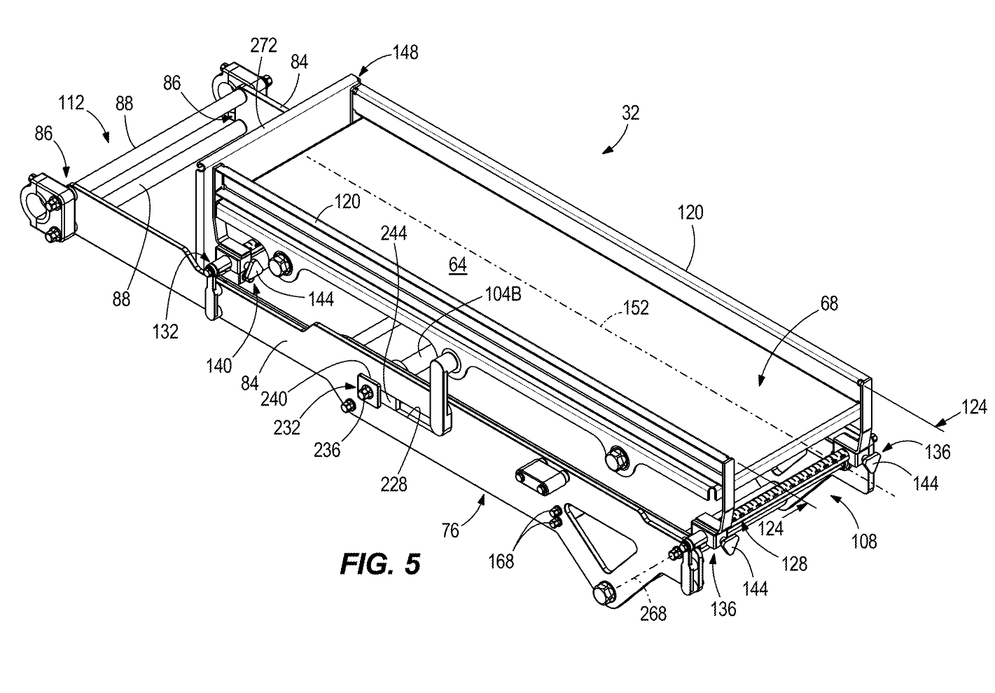

With continued reference to FIGS. 1-4 and further reference to FIGS. 5-7, the tray 32 and associated portions of the slicing apparatus 20 will be described in further detail. In the illustrated example, the tray 32 includes a first or exterior frame 76 and a second or interior frame 80. In the illustrated example, the exterior frame 76 includes a pair of spaced-apart exterior members 84 oriented in a parallel manner relative to each other. The spaced-apart exterior members 84 are coupled to each other at a front end 86 of the exterior members 84. In the illustrated example, the exterior members 84 are rigidly coupled to each other at the front ends 86 thereof and provide a location about which the tray 32 may pivot between a lower or loading position, in which one or more food logs 22 may be loaded onto the tray 32, and an upper or operating position, in which one or more food logs 22 are pivoted upward to a position where the one or more food logs 22 may be sliced. In the illustrated example, a pair of cross members 88 are coupled to and between the front ends 86 of the exterior members 84 to provide rigid coupling of the exterior members 84. A plurality of other cross members 96 extend between and are coupled to the exterior members 84. The cross members 88, 96 associated with the exterior frame 76 provide rigidity to the exterior frame 76.

With continued reference to FIGS. 1-7, the illustrated example of the interior frame 80 includes a pair of spaced-apart interior members 100 oriented in a parallel manner relative to each other. The interior members 100 are positioned to an interior of and between the exterior members 84. Additionally, the interior members 100 are positioned proximate or adjacent to a respective one of the exterior members 84. In the illustrated example, a plurality of cross members 104 extend between and are coupled to the interior members 100. The cross member 104A positioned near the rear end of the tray 32 is also one of the cross members 96A extending between and coupled to the exterior members 84, whereas the cross member 104B positioned near the front end of the interior members 100, the cross members 104B, 104C intermediate of or between the front and rear ends of the interior members 100 and cross member 104D positioned near the front end of the interior members 100 are not coupled to the exterior members 84. The cross members 104 associated with the interior frame 80 provide rigidity to the interior frame 80.

With further reference to FIGS. 1-7, the tray 32 also includes the pan 68 upon which the food product logs 22 are supported. In the illustrated example, the pan 68 is elongated in shape and has a rear end 108 and a front end 112. A plurality of cross members 116 are coupled to and extend between sides of the pan 68 below a bottom surface of the pan 68. The cross members 116 assist with providing rigidity to the pan 68. The illustrated example of the tray 32 also includes a pair of side members or walls 120 positioned, at least in part, above the pan 68 in order to provide an operating width to the pan 68 and inhibit food product logs 22 from falling off the pan 68. In the illustrated example, the side members 120 are adjustable relative to the pan 68 in order to adjust an operating width 124 of the pan 68. Adjusting the operating width 124 of the pan 68 provides the slicing apparatus 20 with the ability to accommodate different quantities of food product logs 22 and/or different sized food product logs 22. In the illustrated example, the side members 120 are coupled to a rear adjustment member 128 and a front adjustment member 132. Each side member 120 includes a rear coupling member 136 and a front coupling member 140 for respectively coupling the side members 120 to the rear and front adjustment members 132, 136. The side members 120 may be coupled to the adjustment members 132, 136 in any manner. In the illustrated example, the coupling members 136, 140 include a selectively adjustable fastener 144 that may be rotated in either direction to selectively tighten and loosen the fastener 144 relative to the adjustment members 136, 140.

With continued reference to FIGS. 1-7, the tray 32 includes a gate or stop member 148 positioned at a front end 112 of the pan 68. In the illustrated example, the gate 148 has a sufficient width to inhibit forward movement of any food product log(s) 22 inserted onto the pan 68. In one example, the gate 148 is at least as wide as the pan 68. In another example, the gate 148 is wider than the pan 68. In another example, the gate 148 is narrower than the pan 68, but still sufficiently wide to inhibit advancement of the food product log(s) 22 on the pan 68. Furthermore, in other examples, the gate 148 may be any width relative to the distance between the side members 120 including wider, narrower and at least as wide as the distance between the side members 120. In the illustrated example, the gate 148 is also positioned between the exterior members 84 of the exterior frame 76. Thus, the gate 148 is narrower that the distance defined between the exterior members 84. The food product log(s) 22 are advanced into the tray 32 along a food product log path defined by an axis 152 as illustrated in FIGS. 5, 7 and 8. The axis 152 is generally parallel to the top surface 64 of the pan 68. In the illustrated example, the gate 148 is positioned generally perpendicular to the food path axis 152 when positioned in an upward or blocking position as illustrated in FIGS. 5-7 (described in more detail below).

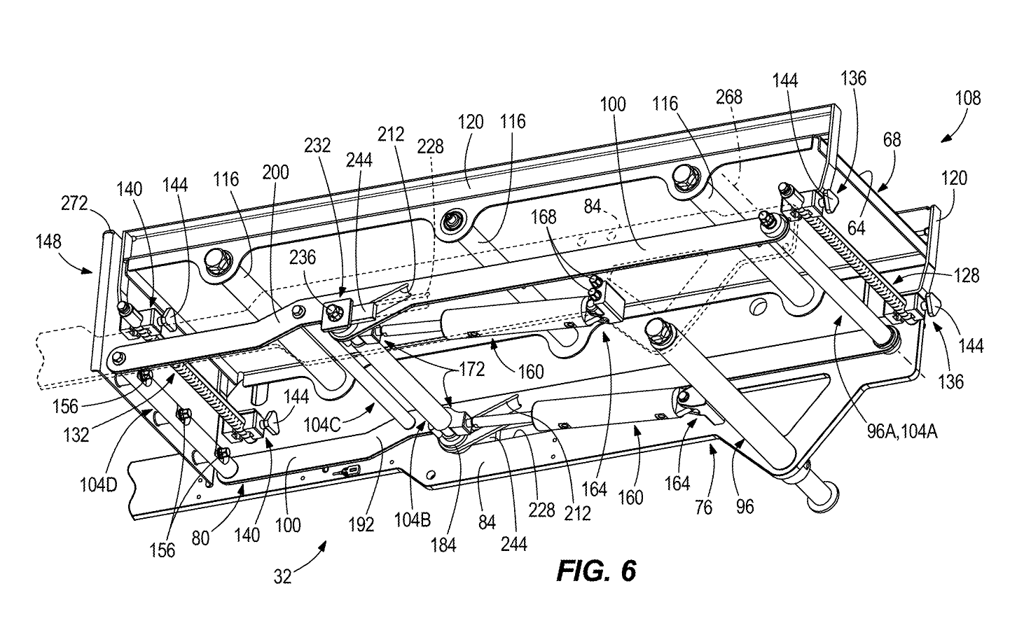

With particular reference to FIG. 6, the gate 148 is coupled to the interior frame 80. In the illustrated example, the gate 148 is coupled to the cross member 104D positioned near the front end of the interior frame 80. The gate 148 may be coupled to the interior frame 80 in a variety of manners and all of such possibilities are intended to be within the spirit and scope of the present disclosure. In the illustrated example, the gate 148 is rigidly coupled to the cross member 104D with three fasteners 156 such that the gate 148, cross member 104D and the remainder of the interior frame 80 move together (described in more detail below).

With continued reference to FIG. 6, the tray 32 also includes at least one actuator 160 coupled to the interior frame 80 for moving at least a portion of the interior frame 80 relative to the exterior frame 76. In the illustrated example, the tray 32 includes a pair of actuators 160 coupled to the interior frame 80 for moving at least a portion of the interior frame 80 relative to the exterior frame 76. In other examples, the tray 32 may include any number of actuators such as, for example, one actuator or more than two actuators, and all of such possibilities are intended to be within the spirit and scope of the present disclosure. The one or more actuators 160 may also be any type of actuator as long as the one or more actuators 160 are capable of moving at least a portion of the interior frame 80 (e.g., the gate) relative to the exterior frame 76. In the illustrated example, the one or more actuators 160 may be a pneumatic actuator or a hydraulic actuator. In another example, the one or more actuators 160 may be a screw drive actuator. Returning now to the illustrated example, the actuators 160 are coupled between the exterior frame 76 and the interior frame 80. One end 164 of each actuator 160 is rigidly coupled to the exterior frame 76 via fasteners 168 and the other end 172 of each actuator 160 is coupled to the interior frame 80 to facilitate movement of at least a portion of the interior frame 80 relative to the exterior frame 76.

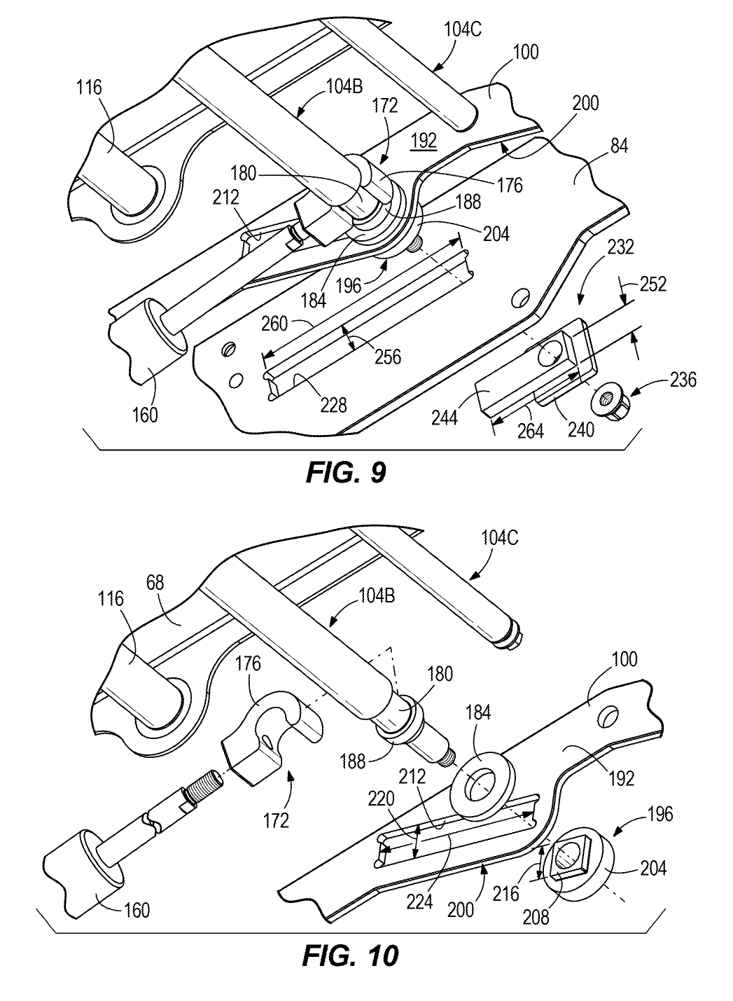

Referring now to FIGS. 6, 9 and 10, the end 172 of one of the actuators 160 is shown in an exploded manner to demonstrate coupling of the actuator 160 to one of the interior members 100. It should be understood that both actuators 160 are coupled to their respective interior members 100 in a similar manner and the following description and associated figures apply to both actuators 160. Only one actuator 160 and interior member 100 will be illustrated and described herein for brevity.

The tray 32 includes another cross member 104B extending between the interior members 100 and the end 172 of the actuator 160 is coupled to the cross member 104B. In the illustrated example, the end 172 of the actuator 160 includes a clamp, hook or other coupling member 176 to selectively and rigidly couple the actuator 160 to the cross member 104B. The cross member 104B includes a recessed or reduced diameter portion 180 configured to receive the clamp or hook 176 of the actuator 160 and inhibit lateral or side-to-side movement of the end 172 of the actuator 160 relative to the cross member 104B. In the illustrated example, a washer 184 is positioned around the cross member 104B between a shoulder 188 of the cross member 104B and an interior surface 192 of the interior member 100 and an interior guide member 196 is positioned around the cross member 104B on an exterior side 200 of the interior member 100. In the illustrated example, the interior guide member 196 includes a head 204 and an interior projection or interior guide 208 positioned in and moveable along a slot 212 defined in the interior member 100. The slot 212 and interior guide 208 may have a complementary shape that facilitates easy movement in one or more desired directions, but inhibits movement of the interior guide member 196 relative to the interior member 100 in one or more undesired directions. In the illustrated example, the interior projection or interior guide 208 is polygonal or square in shape and the slot 212 is elongated and polygonal or rectangular in shape. A height 216 of the interior guide 208 is slightly smaller than a height 220 of the slot 212 to facilitate positioning of the interior guide 208 in the slot 212, but the difference in heights is ever so slight to inhibit substantial movement of the interior guide 208 in the slot 212 in the direction associated with the heights. The interior guide 208 is capable of moving within the slot 212 along the elongated dimension or length of the slot 212 and the length 224 of the slot 212 is determined based on the desired motion of the pertinent portions of the interior frame 80 (described in more detail below).

With continued reference to FIGS. 6, 9 and 10, after the end of the cross member 104B passes through the interior guide member 196, the end of the cross member 104B passes through a slot 228 defined in the exterior member 84 and through an exterior guide member 232. An end cap 236 is threaded onto the end of the cross member 104B on an exterior of the exterior guide member 84 to retain the components associated with the cross member 104B in place. In the illustrated example, the exterior guide member 232 includes a head 240 and an exterior projection or exterior guide 244 positioned in and moveable along the slot 228 defined in the exterior member 84. The slot 228 and exterior guide 244 may have a complementary shape that facilitates easy movement in one or more desired directions, but inhibits movement of the exterior guide member 232 relative to the exterior member 84 in one or more undesired directions. In the illustrated example, the exterior projection or exterior guide 244 is polygonal or rectangular in shape and the slot 228 is elongated and polygonal or rectangular in shape. A height 252 of the exterior guide 244 is slightly smaller than a height 256 of the slot 228 to facilitate positioning of the exterior guide 244 in the slot 228, but the difference in heights is ever so slight to inhibit substantial movement of the exterior guide 244 in the slot 228 in the direction associated with the heights 252, 256. The exterior guide 244 is capable of moving within the slot 228 along the elongated dimension or length 260 of the slot 228 and the lengths 260, 264 of the slot 228 and the exterior guide 244 are determined based on the desired motion of the pertinent portions of the interior frame 80 (described in more detail below).

Referring now to FIGS. 5-8, operation of the tray 32 will be described in more detail. It should be understood that the following description may only set forth some of the manners of operating the tray 32. Such exemplary manners are provided to demonstrate at least some of the principles of the present disclosure and are not intended to be limiting upon the present disclosure. Rather, the tray 32 is capable of being operated in many different manners and including other components to achieve any such operation and all of such possibilities are intended to be within the spirit and scope of the present disclosure.

As indicated above, the gate 148 is capable of stopping or limiting forward advancement of one or more food product logs 22 onto the tray 32. However, in order for the one or more food product logs 22 to be advanced further into the slicing apparatus 20 for slicing, the gate 148 must be moved out of the path of the one or more food product logs 22. The one or more food product logs 22 may apply a relatively large forward force on the gate 148 due to the manner in which the one or more food product logs 22 are loaded onto the tray 32. This forward force may prevent a conventional gate from moving out of the path of the one or more food product logs 22 in a plane perpendicular to the log path defined by the axis 152. Accordingly, the gate 148 of the present disclosure moves both away from leading end(s) of the one or more food product logs 22 and downward or out of the path of the logs 22. Put another way, the gate 148 of the present disclosure moves both away from a front end 112 of the pan 68 and downward below the pan 68 (or at least a top edge 272 of the gate is at least substantially co-planar with the top surface 64 of the pan 68). This dual movement of the gate 148 may also be characterized as a rotation or a pivot along an arc, curve or arcuate path 274 having a radius R (see FIG. 8). As indicated above, the gate 148 is rigidly coupled to the interior frame 80 and the interior frame 80 is pivotally coupled to the exterior frame 76, via the interior members 100, at the cross member 96A, 104A positioned near the rear end 108 of the tray 32. Accordingly, in the illustrated example, the interior frame 80 and gate 148 are pivotal around a pivot axis 268 defined by the cross member 96A, 104A positioned at the rear end 108 of the tray 32. In this example, the dimension of the radius R may be the distance between the axis 268 and the gate 148. Alternatively, the radius R may be any dimension greater or smaller than the distance between the axis 268 and the gate 148, and all of such possibilities are intended to be within the spirit and scope of the present disclosure.

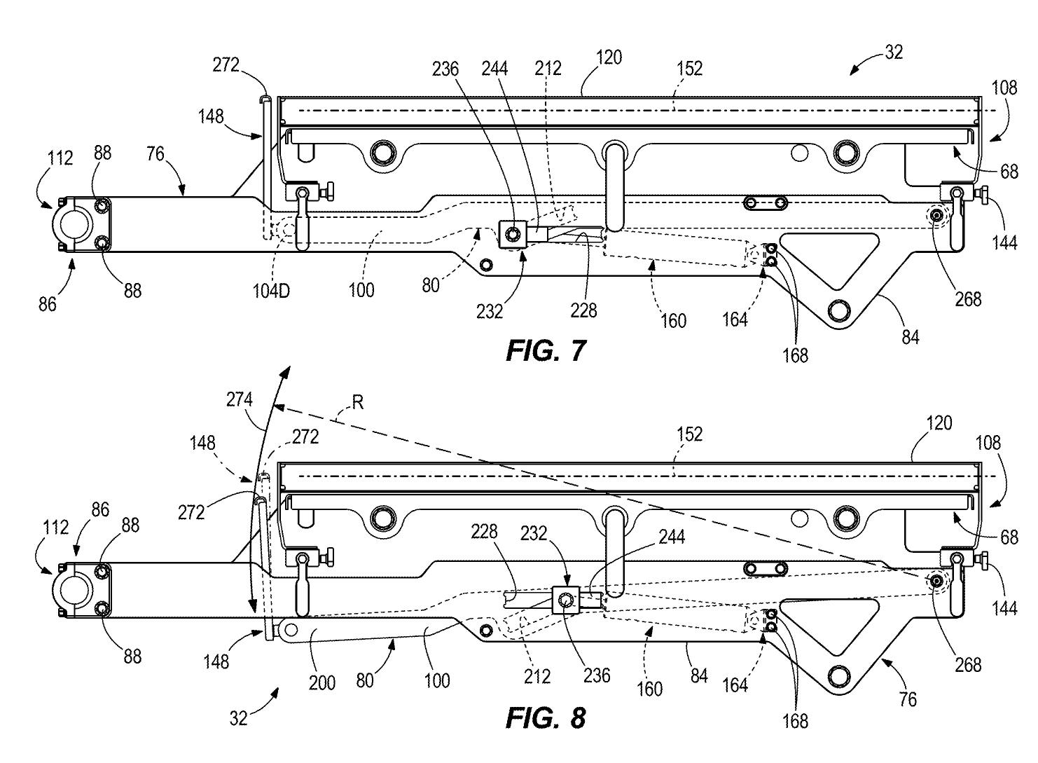

With reference to FIGS. 6 and 7, the gate 148 is shown in an upward or blocking position, in which the gate 148 is positioned in the path 152 of the one or more food product logs 22. With reference to FIG. 8, the gate 148 is shown in a lowered or non-blocking position (in solid lines), in which the gate 148 is out of the path 152 of the one or more food product logs 22 to allow advancement of the one or more food product logs 22 toward the slicing blade 40. The gate 148 is also shown in an intermediate position in FIG. 8 between the upward and lowered positions (shown in phantom lines) to further demonstrate movement of the gate 148.

The actuators 160 are actuated to rotate the interior frame 80 and the gate 148 relative to the exterior frame 76 and the pan 68 between the upward and lowered positions. In the illustrated example, the gate 148 is in the upward position with the actuators 160 in the extended position and is in the lowered position with the actuators 160 retracted. The interaction between the guide members 196, 232 and the slots 212, 228 defined in the exterior and interior members 84, 100 assists with guiding the gate 148 along a desired path.

With reference to FIGS. 5-7, 9 and 10, the components of the tray 32 are in positions associated with the gate 148 being in the upward or blocking position. In this upward position, the interior and exterior guides 208, 244 are positioned in a forward end of their respective slots 212, 228. In one example, engagement between the exterior guides 244 and the forward ends of the slots 228 defined in the exterior members 84 limits upward movement of the gate 148 to set or define the extent of the upward position of the gate 148. In another example, engagement between the interior guides 208 and the forward ends of the slots 212 defined in the interior members 100 limits upward movement of the gate 148 to set or define the extent of the upward position of the gate 148. In yet another example, engagement of both the interior and exterior guides 208, 244 with respective forward ends of their slots 212, 228 limits upward movement of the gate 148 to set or define the extent of the upward position of the gate 148. In a further example, the actuators 160 themselves may be configured to have a limited range of motion to define upward movement of the gate 148 and, in such an example, one or more of the interior or exterior guides 208, 244 may or may not engage forward ends of their respective slots 212, 228.

Upon actuation of the actuators 160 to move the gate 148 from the upward position to the lowered position (see FIG. 8), the actuators 160 pull on the cross member 104B, which results in pulling the interior and exterior guides 208, 244 along their respective slots 212, 228 toward rear ends of the slots 212, 228. The slots 212 defined in the interior members 100 are angled or transverse to the food path axis 152 (when viewed from the side—see, e.g., FIGS. 7 and 8) in order to accommodate or provide the rotational or pivoting movement of the interior members 100 about the pivot axis 268. Since the exterior members 84 do not move, the slots 228 defined in the exterior members 84 are generally horizontal or parallel to the food path axis 152 (when viewed from the side—see, e.g., FIGS. 7 and 8).

The interactions between the guide members 196, 232 and the slots 212, 228 defined in the exterior and interior members 84, 100 assists with guiding the gate 148 along a desired path to the lowered position. With reference to FIG. 8, the components of the tray 32 are in positions associated with the gate 148 being in the lowered or non-blocking position. In this lowered position, the interior and exterior guides 208, 244 are positioned near a rear end of their respective slots 212, 228. In one example, engagement between the exterior guides 244 and the rear ends of the slots 228 defined in the exterior members 84 limits downward movement of the gate 148 to set or define the extent of the lowered position of the gate 148. In another example, engagement between the interior guides 208 and the rear ends of the slots 212 defined in the interior members 100 limits downward movement of the gate 148 to set or define the extent of the lowered position of the gate 148. In yet another example, engagement of both the interior and exterior guides 208, 244 with respective rear ends of their slots 212, 228 limits downward movement of the gate 148 to set or define the extent of the lowered position of the gate 148. In a further example, the actuators 160 themselves may be configured to have a limited range of motion to define downward movement of the gate 148 and, in such an example, one or more of the interior or exterior guides 208, 244 may or may not engage rear ends of their respective slots 212, 228. In the example where the exterior guides 244 engage rear ends of their respective slots 228 to define the lowered position of the gate 148, a length 264 of the exterior guides 244 sets the extent of the lowered position of the gate 148. That is, if the length 264 of the exterior guides 244 is longer, the exterior guides 244 engage the rear ends of the respective slots 228 sooner, thereby setting the lowered position of the gate 148 at a higher position. Conversely, if the length 264 of the exterior guides 244 is shorter, the exterior guides 244 are allowed to travel further and engage the rear ends of the respective slots 228 later, thereby setting the lowered position of the gate 148 at a lower position. In one example, the tray 32 includes a plurality of interchangeable exterior guides 244 having various lengths 264 that may be interchangeably coupled to the tray 32 to adjust the movement of the gate 148 relative to the pan 68. In another example, the exterior guides 244 may themselves be structurally adjustable to adjust a length thereof, thereby enabling adjustment of the gate's movements. In yet other examples, slots 228 defined in the exterior members 84 may be altered or adjustable to adjust a length thereof, thereby enabling adjustment of the gate's movement.

In the upward or blocking position, the gate 148 must be sufficiently above the top surface 64 of the pan 68 in order to limit or stop advancement of the one or more food product logs 22 loaded onto the pan 68. In the lowered or non-blocking position, a top edge 272 of the gate 148 should be at or below the top surface 64 of the pan 68 so as not to interfere with advancement of the one or more food product logs 22 past the gate 148 toward the slicing blade 40.

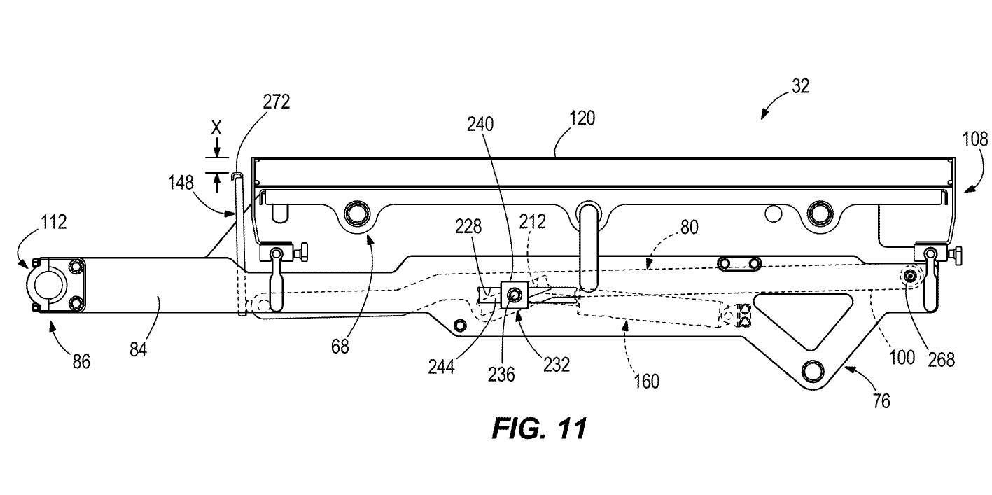

Referring now to FIG. 11, the food product tray 32 of the slicing apparatus 20 shown in FIGS. 1-10 is illustrated in another configuration. In this configuration, the exterior guide members 232 (only one shown) have been coupled to the cross member 104B in another configuration in order to adjust, alter or change movement of the gate 148. In the illustrated example, the exterior guide members 232 are coupled to the cross member 104B in positions that are about 180 degrees rotated from their positions shown in FIGS. 1-10. By repositioning the exterior guide members 232 180-degrees, ends of the exterior guides 244 positioned furthest from the heads 240 of the exterior guide members 232 engage the forward ends of their respective slots 228. In examples where engagement between the exterior guides 244 and ends of the respective slots 228 establishes the upward and lowered positions of the gate 148, movement of the second guides 244 toward forward ends of their respective slots 228 is stopped or limited sooner with the exterior guides 244 in this configuration. Since forward movement of the exterior guides 244 stops sooner, the upward movement of the gate 148 is stopped sooner and the top edge 272 of the gate 148 is not as high as shown in FIGS. 1-10. A difference in height between the top edge 272 of the gate 148 in FIG. 11 and in FIGS. 1-10 may be represented by dimension X in FIG. 11. Dimension X may be any quantity and is adjustable based on the length 264 of the exterior guides 244 and/or the length of the slots 228 defined in the exterior members 84.

Having a lower top edge 272 of the gate 148 may be desirable in situations where the one or more food product logs 22 have a relatively low height. In such situations, the upper infeed member 36A may need to be lowered to engage the top surface of the one or more food product logs 22 having a low height. If the top edge 272 of the gate 148 is at a relatively high position, then the top edge 272 of the gate 148 may interfere with the upper infeed member 36A. By lowering the top edge 272 of the gate 148, the gate 148 may not interfere with the upper infeed member 36A when the upper infeed member 36A is at a lower position.

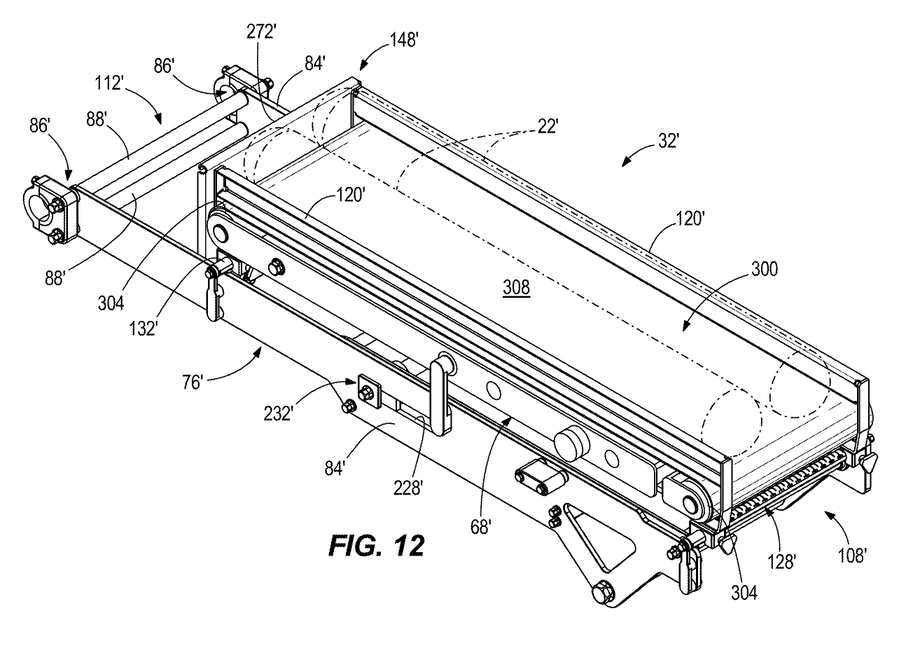

Referring now to FIG. 12, another example of a food product tray 32′ is illustrated. The food product tray 32′ of FIG. 12 has many similar elements to the food product tray 32 in FIGS. 1-11 and such similar elements are identified with the same reference number and an “′”. At least some of the differences between the food product tray 32′ illustrated in FIG. 12 and the food product tray 32 illustrated in FIGS. 1-11 will be described hereinafter.

With continued reference to FIG. 12, the food product tray 32′ includes a transport member 300 to assist with loading one or more food product logs 22′ onto the tray 32′. In the illustrated example, the transport member 300 is a conveyor. The conveyor 300 includes a pair of rollers 304 with one roller 304 positioned at a rear end 108′ of the tray 32′ and the other roller 304 at a front end 112′ of the tray 32′. At least one of the rollers 304 is a drive roller driven by a motor. Either or both of the rollers 304 may be drive roller(s) and in examples where both rollers 304 are driven, the rollers 304 may be driven by one, two or more motors. The conveyor 300 also includes a conveyor belt 308 wrapped around the rollers 304 and extending both above and below the pan 68′. The conveyor 300 is configured to drive or advance one or more food product logs 22′ toward the front end 112′ of the tray 32′ and into contact with the gate 148′. Upon contact of the one or more product logs 22′ with the gate 148′ or just prior to engagement or just after engagement, the conveyor 300 will deactivate and cease driving or advancing the one or more logs 22′.

It should be understood that the use of the terms like first, second, etc., is intended to be used merely for identification purposes to assist with description and understanding of the elements associated therewith. The use of these terms is not intended to be limiting upon the present disclosure. Rather, these terms may be reallocated or interchangeably used with elements for any reasons and any purpose (e.g., with respect to any claims in which these terms or elements associated with these terms are used).

It should also be understood that the use of any orientation or directional terms herein such as, for example, “top”, “bottom”, “front”, “rear”, “back”, “left”, “right”, “side”, etc., is not intended to imply only a single orientation of the item with which it is associated or to limit the present disclosure in any manner. The use of such orientation or directional terms is intended to assist with the understanding of principles disclosed herein and to correspond to the exemplary orientation illustrated in the drawings. For example, the protective headwear may be utilized in any orientation and use of such terms is intended to correspond to the exemplary orientation of the protective headwear illustrated in the drawings. The use of these terms in association with the protective headwear is not intended to limit the protective headwear to a single orientation or to limit the protective headwear in any manner.

While various embodiments of the disclosure have been described, it will be apparent to those of ordinary skill in the art that other embodiments and implementations are possible within the scope of the disclosure. Accordingly, the disclosure is not to be restricted except in light of the attached claims and their equivalents.

1. A food product tray for a slicing apparatus, the food product tray comprising:
a pan including a top surface, a front end and a rear end;
at least one side member extending upward from the pan; and
a gate positioned near the front end of the pan, wherein the gate is moveable between a blocking position, in which a top edge of the gate is positioned above the top surface of the pan, and a non-blocking position, in which the top edge of the gate is either at or below the top surface of the pan, and wherein, during movement of the gate from the blocking position to the non-blocking position, the gate rotates relative to the front end of the pan about an axis displaced from the gate.

2. The food product tray of claim 1, wherein the gate rotates away and downward from the front end of the pan when the gate moves from the blocking position to the non-blocking position.

3. The food product tray of claim 2, wherein the entire gate rotates away and downward from the front end of the pan.

4. The food product tray of claim 2, wherein, with the gate in the blocking position, the gate is spaced-apart from the front end of the pan.

5. The food product tray of claim 1, wherein the axis is positioned between the front end and the rear end of the pan.

6. The food product tray of claim 1, wherein the gate is positioned on a first side of the front end of the pan and the axis is positioned on a second side of the front end of the pan opposite the first side.

7. The food product of claim 1, wherein, with the gate in the non-blocking position, the top edge of the gate is below the top surface of the pan.

8. The food product tray of claim 7, wherein, with the gate in the non-blocking position, food product configured to be supported on the pan and advanced off of a front end of the pan does not engage the gate.

9. The food product tray of claim 1, further comprising a frame member coupled to the gate, wherein the frame member is rotatable about the axis, and wherein rotation of the frame member about the axis moves the gate between the blocking position and the non-blocking position.

10. The food product tray of claim 9, further comprising a second frame member, wherein the first frame member and the second frame member interact to define the blocking position and the non-blocking position.

11. The food product tray of claim 10, wherein the first frame member defines a first slot therein and the second frame member defines a second slot therein, wherein the first slot and the second slot are transversely oriented relative to each other.

12. The food product tray of claim 11, further comprising a first guide member at least partially positioned in the first slot and a second guide member at least partially positioned in the second slot, wherein the first guide member moves within the first slot and the second guide member moves within the second slot as the gate moves between the blocking position and the non-blocking position.

13. The food product tray of claim 12, wherein at least one of the first guide member and the second guide member engages an end of a respective one of the first slot and the second slot to define one of the blocking position and the non-blocking position.

14. A slicing apparatus comprising:
a housing;
a slicing blade supported by the housing and configured to move in order to slice food product;
a food product tray supported by and movable relative to the housing between a loading position, in which the food product tray is configured to receive at least one food product thereon, and an operating position, in which the food product is raised relative to the loading position, wherein the food product tray includes
a pan including a top surface, a front end and a rear end,
at least one side member extending upward from the pan, and
a gate positioned near the front end of the pan, wherein the gate is moveable between a blocking position, in which a top edge of the gate is positioned above the top surface of the pan and is configured to inhibit the at least one food product from advancing past the gate, and a non-blocking position, in which the top edge of the gate is moved to a position lower than in the blocking position to allow the at least one food product to advance past the gate, and wherein the gate moves along an arcuate path during movement of the gate from the blocking position to the non-blocking position, and wherein the arcuate path is defined by an axis displaced from the gate and a radius between the arcuate path and the axis; and
an infeed member configured to engage the at least one food product supported on the food product tray, wherein the infeed member is configured to advance the at least one food product past the gate and toward the slicing blade with the gate in the non-blocking position.

15. The slicing apparatus of claim 14, wherein the gate rotates away from the front end of the pan and downward when the gate moves from the blocking position to the non-blocking position.

16. The slicing apparatus of claim 15, wherein, with the gate in the blocking position, the gate is spaced-apart from the front end of the pan.

17. The slicing apparatus of claim 14, wherein the axis is positioned between the front end and the rear end of the pan.

18. The slicing apparatus of claim 14, wherein the gate is positioned on a first side of the front end of the pan and the axis is positioned on a second side of the front end of the pan opposite the first side.

19. The slicing apparatus claim 14, wherein, with the gate in the non-blocking position, the top edge of the gate is at or below the top surface of the pan.

20. The slicing apparatus of claim 19, wherein, with the gate in the non-blocking position, the at least one food product does not engage the gate as the infeed member advances the at least one food product past the gate.

21. The slicing apparatus of claim 14, wherein the food product tray further includes a frame member coupled to the gate, wherein the frame member is rotatable about the axis, and wherein rotation of the frame member about the axis moves the gate between the blocking position and the non-blocking position.

22. The slicing apparatus of claim 21, wherein the food product tray further includes a second frame member, wherein the first frame member and the second frame member interact to define the blocking position and the non-blocking position.

23. The slicing apparatus of claim 22, wherein the first frame member defines a first slot therein and the second frame member defines a second slot therein, wherein the first slot and the second slot are transversely oriented relative to each other.

24. The slicing apparatus of claim 23, wherein the food product tray further includes a first guide member at least partially positioned in the first slot and a second guide member at least partially positioned in the second slot, wherein the first guide member moves within the first slot and the second guide member moves within the second slot as the gate moves between the blocking position and the non-blocking position.

25. The slicing apparatus of claim 24, wherein at least one of the first guide member and the second guide member engages an end of a respective one of the first slot and the second slot to define one of the blocking position and the non-blocking position.
